(19) United States
(12) Patent Application Publication
(10) Pub. No.: US 2023/0288265 A1
(43) Pub. Date: Sep. 14, 2023

(54) METHOD FOR MONITORING TEMPERATURE OF PRODUCT DELIVERIES FROM ORIGIN TO DESTINATION

(71) Applicant: HOME VALET, INC., Vienna, VA (US)

(72) Inventors: John SIMMS, Vienna, VA (US); John Simms, JR., Vienna, VA (US); Michael Seeley, Vienna, VA (US); Joey Bertalan, Vienna, VA (US); Patrick Boarman, Vienna, VA (US)

(73) Assignee: HOME VALET, INC., Vienna, VA (US)

(21) Appl. No.: 18/181,249

(22) Filed: Mar. 9, 2023

Related U.S. Application Data
(60) Provisional application No. 63/319,018, filed on Mar. 11, 2022.

(51) Int. Cl. G01K 1/024; F25D 29/00; H04Q 9/00; G06Q 10/0832

(52) U.S. Cl. CPC G01K 1/024; F25D 29/003; H04Q 9/00; G06Q 10/0832; F25D 2700/12

(57) ABSTRACT

A method of monitoring, via a temperature sensor, a temperature of a container that stores an item. There is a first step of periodically measuring the temperature of the interior compartment of the container, and the first step occurs while the container is stationary. Subsequently, there is a second step of periodically measuring the temperature of the interior compartment of a container, and the second step occurs while the container is being transported by a vehicle to a destination. Subsequently, there is a third step of periodically measuring the temperature of the interior compartment, and the third step occurs after the container has been delivered to the destination and while the container is stationary. In addition the method includes periodically transmitting information comprising the measured temperatures from the first, second, and third steps to a server, and storing the measured temperatures.

### CROSS-REFERENCE TO RELATED APPLICATIONS

This application claims the benefit of U.S. Provisional Application No. 63/319,018, filed Mar. 11, 2022.

### BACKGROUND

A method for monitoring the temperature of product deliveries from the origination point to the final destination is disclosed in the present application (Store to Door). The temperature of the products can be monitored continuously from the moment they are loaded into the transport delivery receptacle (cooler or equivalent) all through the delivery route and until they are removed from the delivery receptacle. The method of temperature measurement can include a wireless signal transmission of temperature which is taken via a thermistor or equivalent method of measurement and transmitted to the delivery driver's smartphone app. The app will in turn transmit the temperatures periodically via cellular communication through a gateway to the internet. The temperatures can be collected and stored on a cloud based server and will be accessible via any connected device on the HomeValet (or other provider service) to authorized users. The data can be used to monitor food chain temperature compliance, evaluate and optimize delivery routes and set target delivery times based on temperature measurement and degradation predictions. Additionally, the data can be used to alert the delivery driver when a scheduled delivery time may or has expired and allow the driver to take appropriate action.

With the increased demand for home delivery of groceries, ensuring food chain temperature monitoring and compliance is rapidly becoming an area of concern. The present system will eliminate the present “unknown” temperature environment that exists with uncontrolled and or unmonitored deliveries as are common with present delivery services. Most current couriers are delivering groceries in personal vehicles with or without the aid of coolers or other insulation methods. Most if not all of these storage containers are passively temperature controlled and not data monitored. As a result, the perishables contained in the deliveries can become spoiled or otherwise damaged without the knowledge of the courier or the ultimately the final customer.

It would be advantageous to provide a vessel/receptacle that includes independent intelligent sensing and a thermal management system designed to allow interchangeable receptacles to be transported, monitored and maintained to control and comply with for current or future cold chain compliance regulations. This system may have proprietary air and power attachment interfaces to allow interdependent companies and transport agencies to use one system and connect via a platform to monitor, transport, deliver and receive goods from retailer, distributor to home or businesses.

Multiple docking systems can be used in series to allow this transportation flow to be seamless between the different logistic phases of a package or delivery journey: the distributor may have a system for storing and pick up; the delivery entity may have a system for vehicles (independent or commercial vehicles); and the home or business end user has a system for the receiving of the delivery. In each phase, regardless of which entity's system is being used, from a store, during delivery, and to the customer's door, a container with temperature sensitive items can be monitored in terms of temperature to comply with cold chain requirements.

### SUMMARY

A method of monitoring, via a temperature sensor, a temperature of a container that stores an item. There is a first step of periodically measuring the temperature of the interior compartment of the container, and the first step occurs while the container is stationary. Subsequently, there is a second step of periodically measuring the temperature of the interior compartment of a container, and the second step occurs while the container is being transported by a vehicle to a destination. Subsequently, there is a third step of periodically measuring the temperature of the interior compartment, and the third step occurs after the container has been delivered to the destination and while the container is stationary. In addition the method includes periodically transmitting information comprising the measured temperatures from the first, second, and third steps to a server, and storing the measured temperatures.

In another embodiment, there is a method of monitoring a temperature of an interior compartment of each of a first container, a second container, and a third container that successively store an item during a delivery process. The method includes a first step of periodically measuring the temperature of the interior compartment of the first container with a first temperature sensor, the first step occurring while the first container is stationary and stored at a delivery source; a second step of periodically measuring the temperature of the interior compartment of the second container with a second temperature sensor, the second step occurring while the second container is being transported by a vehicle to a destination and after the first step; and a third step of periodically measuring the temperature of the interior compartment of the third container with a third temperature sensor, the third step occurring while the third container is stationary, present at a delivery destination, and after the second step.

### BRIEF DESCRIPTION OF THE DRAWINGS

Aspects of the present disclosure are further described in the detailed description which follows in reference to the noted plurality of drawings by way of non-limiting examples of embodiments in which like reference numerals represent similar parts throughout the several views of the drawings.

FIG. 1 illustrates a high-level overview of the hardware environment used in the present disclosure.

FIG. 2A illustrates a tracking device that measures temperature inside a container, determines location, and transmits information wirelessly to a cloud server.

FIG. 2B illustrates how the tracking device is placed inside the container manually.

FIG. 2C illustrates a block diagram of hardware components of the tracking device.

FIG. 3 illustrates another embodiment of the container with a divider wall and two tracking devices housed therein.

FIGS. 4A illustrates various embodiments of the container.

FIG. 4B illustrates an external cooling system that can cool the interior of the container.

FIG. 5 illustrates a block diagram of the container and hardware components that may be integrated therein.

FIGS. 6A and 6B illustrate how the container can be integrated with a wall or a vehicle.

FIGS. 7A-7B illustrate how the container can be integrated at a user's home.

FIGS. 8A-8D illustrate how the container can be docked to an actively cooled larger container, how multiple containers can be docked to a vehicle, and how a container can be docked to a wall at a user's home (i.e. a delivery location).

FIG. 9 illustrates a flowchart of a temperature monitoring process.

FIG. 10 illustrates how the temperature can be monitored continuously or periodically from a delivery source, during transport, and after delivery to a delivery destination.

FIGS. 11A and 11B illustrate display screens that display location history and temperature history for the interior of the container.

FIGS. 12A and 12B illustrate additional display screens that may be displayed on a terminal device.

FIG. 13 illustrates an insulated sheet that covers goods and monitors temperature data.

FIGS. 14A-14C illustrate a cubby permanently installed at a user's home that receives delivered goods, refrigerates the goods, and monitors temperature data.

FIG. 15 illustrates an alternative embodiment of the container that monitors and regulates its temperature.

FIG. 16 illustrates small caddies that can be placed in the container.

### DETAILED DESCRIPTION

Exemplary embodiments are described herein with reference to block diagrams and flowchart illustrations of methods, apparatus (e.g., systems), and computer program products according to various aspects. It will be understood that each functional block of the block diagrams and the flowchart illustrations, and combinations of functional blocks in the block diagrams and flowchart illustrations, respectively, can be implemented by computer program instructions. These computer program instructions may be loaded onto any combination of general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks. The memory may be a non-volatile memory.

It should be appreciated that the particular implementations shown and described herein are illustrative of the disclosure and its best mode and are not intended to otherwise limit the scope of the present disclosure in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

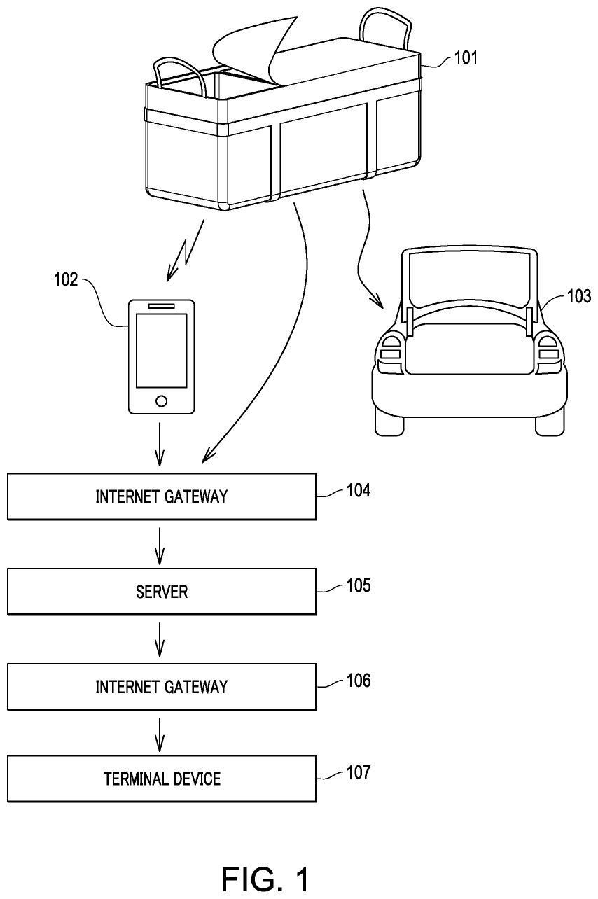

Referring to FIG. 1, which illustrates an overall hardware environment, embodiments of the present disclosure include a container 101, a first terminal device 102, a vehicle 103, a first internet gateway 104, a server 105, a second internet gateway 106, and a second terminal device 107.

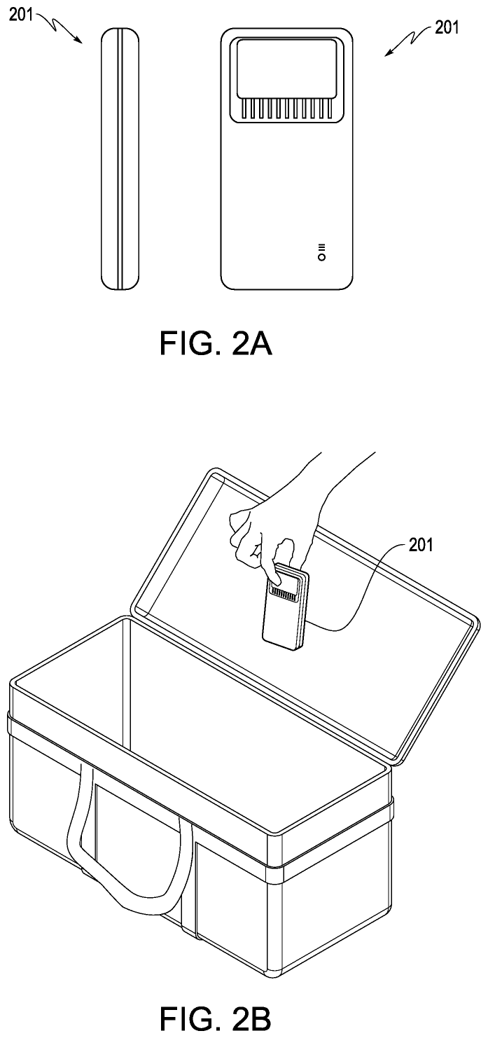

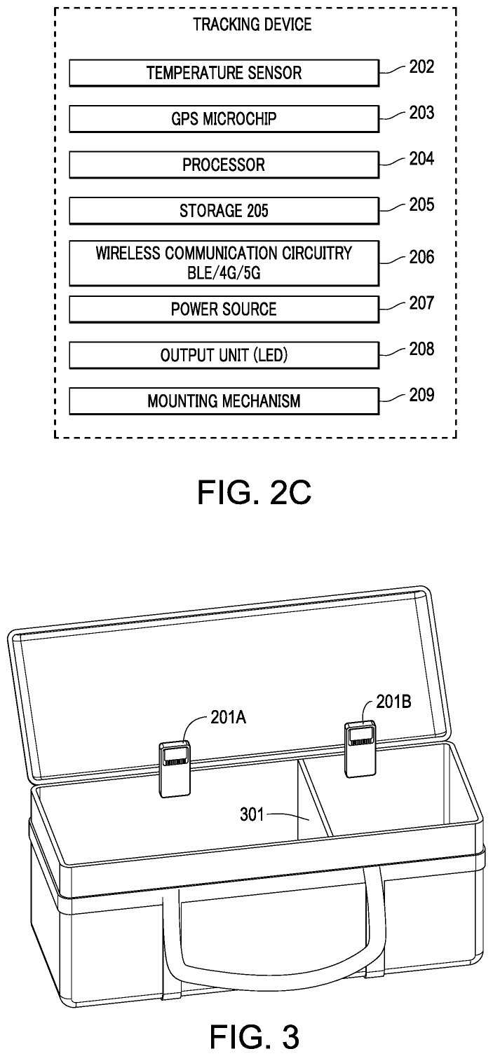

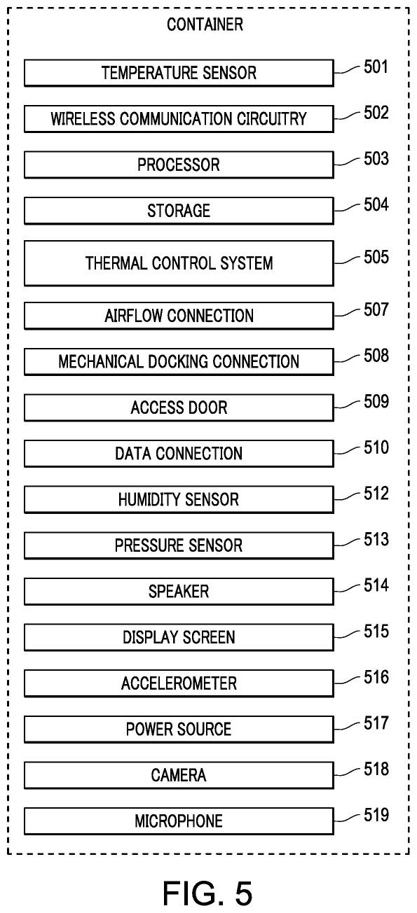

The container 101 is an insulated container that has at least one interior compartment that can store food and/or beverages. The container 101 may of course include multiple compartments therein. The container 101 may include an active cooling system that keeps the interior compartment at a preset temperature, or the container 101 can be passively cooled via insulation like a cooler. The container 101 may include therein a temperature sensor such as a thermistor and other hardware components such as wireless communication circuitry that will be described in detail with respect to FIGS. 2 and 5. Note that the temperature sensor and the wireless communication circuitry may be housed within a separate tracking device that is manually placed inside the container, as shown in FIG. 2A, but in an alternative embodiment the temperature sensor and the wireless communication circuitry may be physically integrated and mounted into the container. The container may be a soft container such as a bag, or a rigid container such as a cooler.

The tracking device or the container itself 101 may, by way of the wireless communication circuitry, communicate with the first terminal device 102, the internet gateway 104, or both devices. The tracking device or the container can communicate with the server 105 via the first terminal device 102 and/or the internet gateway 104.

The first terminal device 102 can be a smartphone, but other types of electronic devices such as a tablet, a smartwatch, a laptop, or a computing device mounted integrally with the vehicle 103 could also be implemented. The first terminal device 102 includes a processor, memory, a display, and wireless communication circuitry. The first terminal device may be owned and/or associated with the driver of the vehicle 103.

The vehicle 103 can be any type of vehicle that is capable of carrying the container 101 in one way or another. That is, the vehicle could be a sedan, a truck, an SUV, et cetera. The vehicle 103 could potentially even be a motorcycle or an electric bicycle that is configured to carry the container 101. The vehicle could be gas powered or electrically powered.

The internet gateway 104 is a network node that is between the container 101 or the first terminal device 102 and the internet. The internet gateway 104 could be a cell phone tower or a Wi-Fi router, for example.

The server 105 is a cloud-based server that includes a processor, memory, storage, and so forth that is connected to the internet. The server 105 can receive data from the container 101, the tracking device 201, or the first terminal device, store data and various programs, including the temperature data measured by the container 101, and transmit data to the container 101 or the first terminal device 102 or the second terminal device 107 over the internet connection. The temperature data can be measured over time so that multiple time points have temperature measurements. The server 105 could also store location data that indicates location history of the container 101. Similarly, the location can be tracked over time so that multiple time points have locations associated therewith, so that a route taken by the container over time can be deduced.

The internet gateway 106 is a network node that is between the server 105 and the second terminal device 107. The internet gateway 106 could be a cell phone tower or a Wi-Fi router, for example.

The second terminal device 107 can be a smartphone, but other types of electronic devices such as a tablet, a smartwatch, a laptop, or a desktop computer could also be implemented. The second terminal device 107 includes at least a processor, memory, a display, and wireless communication circuitry. The second terminal device 107 may be owned and/or associated with a user who orders food or a perishable, temperature sensitive item over the internet. The second terminal device 107 can receive data from the container 101 and/or the first terminal device 102, and transmit data to the same components, via at least the cloud server 105.

FIG. 2A illustrates an exemplary embodiment of the tracking device 201. In this embodiment, the container 101 may be a relatively simple construction that does not include electronic components. The tracking device 201 measures temperature from an area around itself, and also determines its own location via a GPS chipset and antenna. The tracking device 201 is placed inside the container 101 manually by a user, as shown in FIG. 2B. As a result, the tracking device 201 determines the temperature inside the container 101 even if the container is a pre-existing plastic cooler or the like devoid of electronics.

FIG. 2B illustrates how a user can simply place the tracking device 201 inside the container by hand so that the interior of the container 101 can have its temperature monitored. The tracking device 201 may be loosely disposed within the container without any sort of lock or secure mechanical connection, but in another embodiment the tracking device 201 can be mechanically secured to a sidewall, lid, or bottom wall of the container so that the tracking device 201 is held in place. That is, a clip may be included on the tracking device 201 that attaches to a recess on the wall of the container.

FIG. 2C illustrates the hardware components of tracking device 201.

A temperature sensor 202 is included. The temperature sensor could be a thermistor, a thermocouple, or a resistance temperature detector. Multiple temperature sensors could of course be implemented to improve accuracy or provide redundancy in case of a single point of failure. The temperature sensor 202 measures the temperature of the ambient environment repeatedly.

A GPS microchip 203 with an antenna may be included. The GPS microchip 203 measures location of the tracking device 201.

A processor 204 is also included. The processor (i.e., a CPU, PLC or microcontroller) controls, by executing at least one program or software, overall operations of the tracking device 201, such as the temperature sensor 202, and the other components shown in FIG. 2C.

The storage 205 stores data and/or programs. The processor can execute the programs stored in the storage 205. The storage can store the data collected by the temperature sensor 202 before, during or after the temperature data is sent to the server. The storage can be implemented with a non-volatile medium such as flash memory or an SSD. A volatile memory such as DRAM can also be provided separately to operate with the processor 204. A program for controlling the temperature of the container 101 and/or for transmitting the temperature measurements from the temperature sensor 202 may be provided in the storage.

Wireless communication circuitry 206 is also provided, so that the tracking device 201 can transmit temperature data from the temperature sensor 202 to a server, a cell phone tower, or a driver's smartphone such a terminal device 102. Additionally, the wireless communication circuitry 206 can enable reception of data, software updates, or instructions from an external electronic device. The wireless communication circuitry 206 may be configured to implement communication via Wi-Fi, LTE, 4G, 5G, Bluetooth, NFC, LoRa, or other types of wireless communication. The wireless communication circuitry 206 may include an antenna and/or a transceiver. Of course, the wireless communication circuitry 206 could also be configured to implement several of these communication methods. The wireless communication circuitry 206 could also enable communication with the container 101 if the container 101 is a “smart” box that also includes e.g. a processor and its own wireless communication circuitry.

A power source 207 is included. The power source 207 may be a lithium ion battery, but other battery chemistries could alternatively be used.

The output unit 208 communicates information to a user who is physically close to the tracking device 201. The output unit may be a simple LED light, but it could also be a small display screen or a speaker. Of course, a plurality of LED lights could be used. The output unit 208 could indicate that temperature monitoring is active when the LED light flashes green, for example. If the output unit is a display screen, the screen could visually indicate that temperature monitoring is active, and/or display the measured temperature.

The mounting mechanism 209 is a mechanical connection such as a clip, lock, magnet, or protrusion that physically secures the tracking device 201 to the container 101 to prevent the tracking device 201 from jostling inside the container.

With the above components, the tracking device 201 can easily be placed inside the container so as to continually or periodically collect temperature data and optionally location data, store the data, and transmit the data, or processing results based on the data such as whether the temperature exceeds a predetermined threshold, to a driver's smartphone or a server. Thus, the temperature inside the container can be monitored over relatively long periods of time, starting from a delivery source (i.e. a store), during transport, and up to and including a delivery destination (to door). This helps ensure that the goods in the container are kept at an appropriately cold temperature from store to door. The temperature history and location history can be displayed on a screen as described in further detail below. This ensures that temperature sensitive goods are delivered without exceeding a preset temperature, and prevents spoilage of the temperature sensitive goods.

FIG. 3 illustrates an alternative embodiment of the container 101, where a divider wall 301 is present, and two tracking devices 201A and 201B are disposed on each side of the divider wall. That is, multiple tracking devices can be housed within a single container. This may be useful if two separate deliveries are being made, or if two separate temperature zones are required.

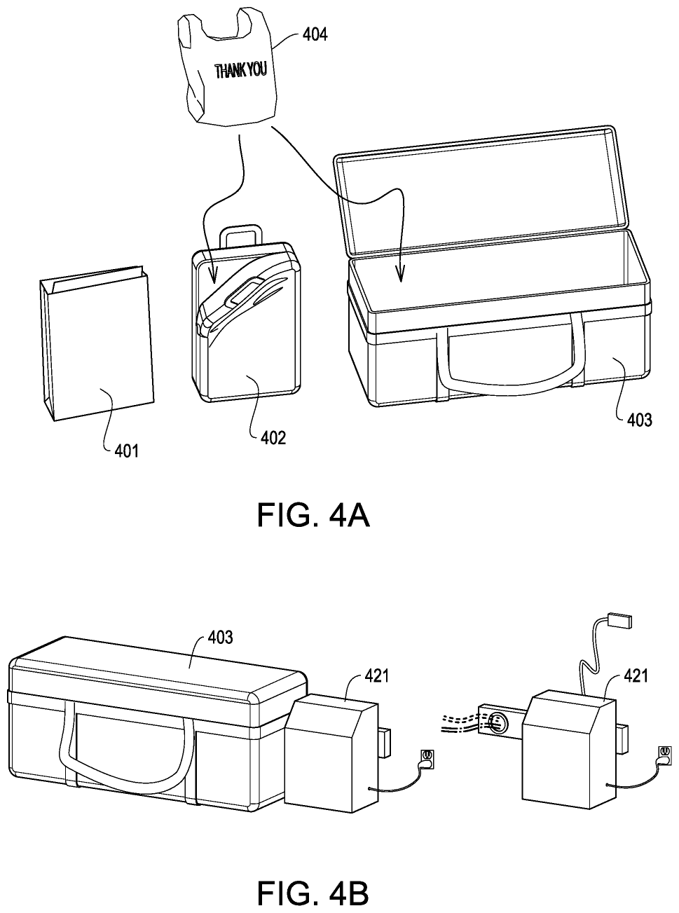

FIGS. 4A and 4B illustrate several different embodiments of the container. In FIG. 4A, container 401 is a simple open-top bag that can be fold shut or sealed shut. Container 402 is able to be closed by actuating a zipper, like a backpack. Container 403 is a cooler-type container with a lid that can rotate. A separate disposable plastic bag 404 with “thank you” printed thereon may be used as a secondary interior bag that prevents contains 401-403 from becoming stained with food or liquid. The containers 401-403 may optionally include an RFID tag or QR code to identify and track the contents of the container.

In FIG. 4B, the container can be attached to or separated from a thermal control system 421 that cools the interior of the container. In other words, the container may have various physical configurations. Any of these embodiments may include insulation on the bottom side, sidewalls, or lid. During the delivery process from store to door, the container 101 could be connected to the thermal control system 421 at various time periods. In one example, the thermal control system 421 is only present at the destination, so the goods can be actively cooled after delivery. In another example, the thermal control system 421 is present at the delivery source and at the destination, but not present in the vehicle during transport. In another example, the thermal control system 421 is present at all three steps, namely, at the delivery source, during transport, and at the destination. Thus, varying degrees of active cooling can be applied when the goods are delivered from store to door.

In the embodiment described above, the container 101 is a simple construction made from plastic or fabric, and the electronic components are disposed within the tracking device 201, and the tracking device 201 is manually placed inside the container. In other words, the container may be devoid of electronic components. In another embodiment, the container 101 is a “smart” container with electronic components mounted therein, such as the temperature sensor and the wireless communication circuitry. The tracking device 201 is thus essentially physically integrated with the container in this embodiment, rather than being a separate component that is manually placed inside the container.

FIG. 5 illustrates a block diagram of certain hardware components of the container 101 when the container is a “smart” container. Some of these components may be omitted in practice.

A temperature sensor 501 monitors the temperature of the interior compartment of the container repeatedly. The temperature sensor could be disposed on any portion of the interior of the container. The temperature sensor could be a thermistor, a thermocouple, or a resistance temperature detector. Multiple temperature sensors could of course be implemented to improve accuracy or provide redundancy in case of a single point of failure. In addition, the container 101 could include one or more temperature sensors on the exterior of the container, at any location such as the top or sides of the container. These exterior temperature sensors could measure the ambient temperature, and the ambient temperature data could be processed to calculate cooling performance, i.e. a difference between exterior temperature and interior temperature.

In addition, the container could include at least one UV sensor (not shown) on the top or side portion. Output from the UV sensor could be sent to the processor to determine if the container has been left in the sun for a predetermined period of time or longer.

Wireless communication circuitry 502 is also provided, so that the container 101 can transmit temperature data from the temperature sensor 501 to a server, a smartphone, or a cell phone tower and then onto the server. Additionally, the wireless communication circuitry 502 can enable reception of data, software updates, or instructions from an external electronic device. The wireless communication circuitry 502 may be configured to implement communication via Wi-Fi, LTE, 4G, 5G, Bluetooth, NFC, LoRa, or other types of wireless communication. LoRa is a low power wide area network modulation technique. The wireless communication circuitry 502 may include an antenna and/or a transceiver. The wireless communication circuitry 502 could receive data from the tracking device 201 and retransmit the data to cell phone tower, and then onto a cloud server.

A processor 503 (i.e., a CPU, PLC or microcontroller) controls overall operations of the container 101, such as the temperature sensor 501 and the wireless communication circuitry 502, and the other electronic components shown in FIG. 5. For example, the processor 503 can control the temperature sensor 501 to repeatedly take temperature measurements, and transmit the temperature measurements to a cloud server that is external to the container 101 via the wireless communication circuitry 502. The processor could be a plurality of processors that cooperatively function to control operations of the container. The processor is configured to receive data from, and control all electronic components in the container 101.

The storage 504 stores data and/or programs. The processor can execute the programs stored in the storage 504. The storage can store the data collected by the temperature sensor 501 before, during or after the temperature data is sent to the server. The storage can be implemented with a non-volatile medium such as flash memory or an SSD. A volatile memory such as DRAM can also be provided separately to operate with the processor 503. A program for controlling the temperature of the container 101 and/or for transmitting the temperature measurements from the temperature sensor 501 may be provided in the storage.

The thermal control system 505 is an active temperature control system that can maintain the interior compartment of the container at a predetermined temperature. The thermal control system 505 may be a modular component that is physically separable from the container, as shown in FIG. 4B, that receives warm air from the container and outputs cold air to the container. For example, the thermal control system 505 could maintain the interior compartment at a refrigeration temperature of about 35-40 degrees F., or at a freezing temperature of about −5 to 5 degrees F. The thermal control system 505 may include control electronics, an evaporator, a compressor, a condenser, an expansion valve, refrigerant fluid, a fan, and/or other components that may be used to generate cool or warm air.

Several connection interfaces will now be described. The purpose of the connection interfaces is to enable the container to be mechanically connected at various places such as a food preparation business, a delivery vehicle, and a user's home, and receive temperature controlled air through the interfaces from an external source. Optionally, a data port can also be included via which temperature data can be transmitted from the container 101 to an external source.

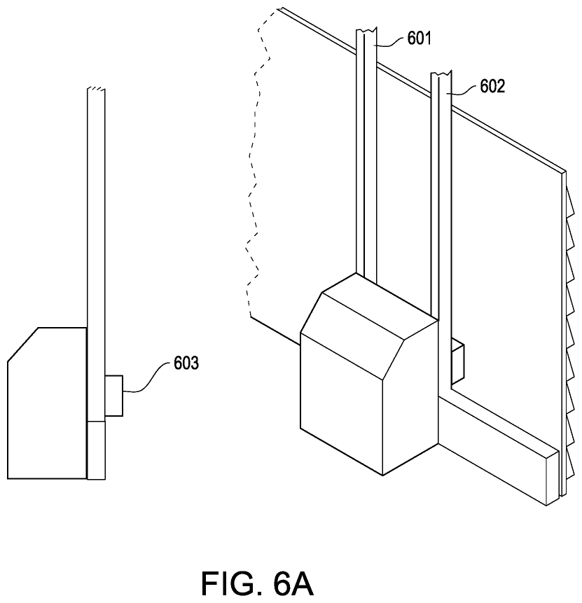

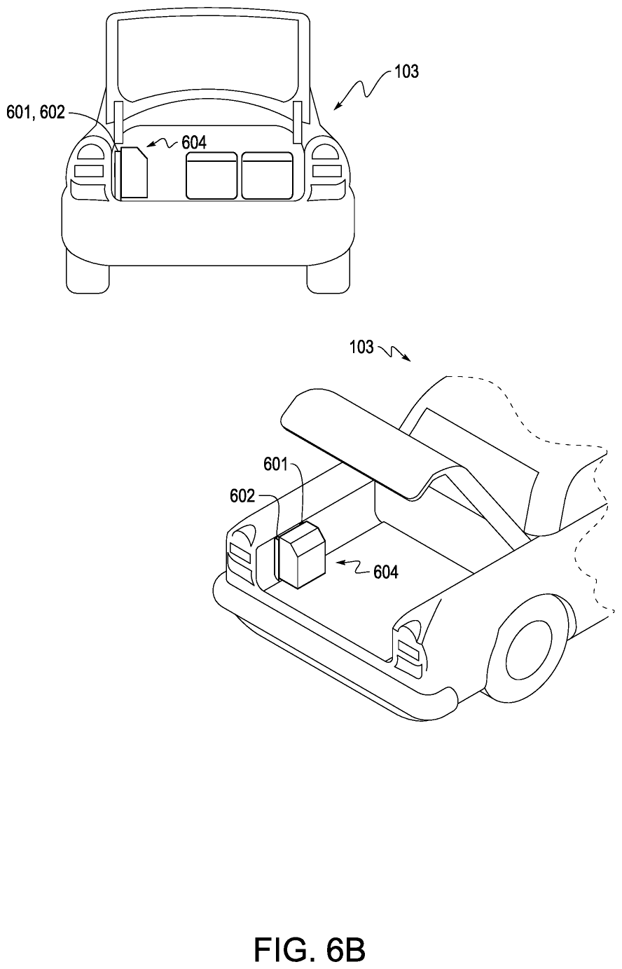

A mechanical docking connection interface 508 is provided. This docking connection can be in the form of a protrusion or set of protrusions that is configured to fit into a guide rail or a pair of guide rails. By this configuration, the container 101 can be slidingly fit onto a wall on which the guide rail is disposed. The guide rail could be disposed on a wall that is part of a user's home, or on a wall that is part of a place of business such as a restaurant (as in FIG. 6A) or on the interior of a vehicle (as in FIG. 6B).

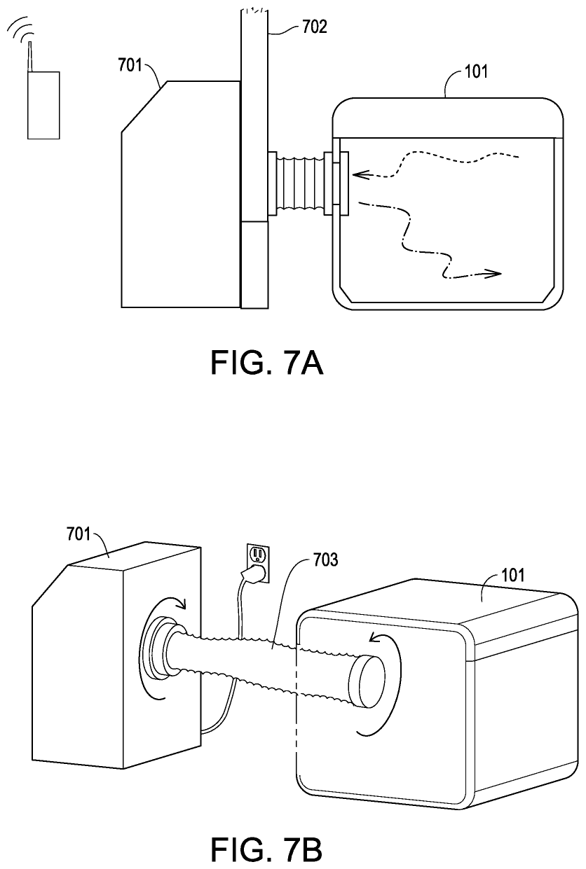

The container may also include an airflow connection interface 507. By this interface, cold air at a predetermined temperature can be delivered from an external source (i.e., a refrigeration unit), through a pipe, and to the interior of the container 101. The airflow connection 507 interface may be a port through which the cold air passes. That is, the container 101 does not include an active thermal control system integrated therewith, and is instead kept at a predetermined temperature via airflow supplied from the external source and through the pipe. FIGS. 7A and 7B illustrate this connection interface in more detail.

An access door 509 is provided which may simply be a sliding door or a hinged door that when moved, allows access to the interior compartment.

Optionally, a data communication interface 510 can be provided. The data communication interface 510 permits transfer of data to and from the container 101. For example, temperature data from the temperature sensor 501 could be sent from the container to an external source that physically connects to the container.

The container may also include a humidity sensor 512, a pressure sensor 513, a speaker 514, and a display screen 515.

Optionally, the container 101 may also include a GPS microchip/receiver (not shown) with an antenna which receives GPS signals from satellites. The processor 204 can calculate location of the container based on signals from the GPS receiver.

The container may also include an accelerometer 516 that measures shock forces or g forces. The accelerometer would be in communication with the processor 503, and the processor could receive the acceleration information, and store the acceleration information in the storage 504. The processor could then determine whether the container has been subject to a high level of shock by comparing the acceleration information to a predetermined threshold. A user could then be warned that the container and/or its contents have potentially been damaged.

The container could also include a power source 517 such as a battery or power conversion circuitry that enables reception of power from a wall plug or other external source. The battery could be a lithium-ion battery, but other chemistries could be implemented.

The container could also include a camera 518 and a microphone 519. These two components can transmit information to the processor 503, and the processor may be programmed to perform machine learning on the information that is received. The processor could also transmit information from the camera 518 and the microphone 519 to a server for processing in the cloud.

With the components shown in FIG. 5, the “smart” container can monitor its temperature repeatedly over time, store the data, and transmit the temperature data to a server. The container can also track its location over time. Due to the mechanical docking connection interface 508 and the airflow connection interface 507, the container can be physically docked at a delivery source (i.e. a warehouse, store, or restaurant) and receive cooling air at the delivery source from an external refrigeration unit so as to keep the interior of the container, and thus the goods inside, at a predetermined cold temperature (i.e., a refrigeration temperature of 35-40 degrees, or a freezing temperature of 0-10 degrees, though the exact temperature is not particularly limited). This helps ensure that the goods are kept at an appropriately cold temperature from store to door. The mechanical docking connection interface 508 can also be used to dock the container on a vehicle or at a user's home when the vehicle or home has a corresponding port.

Note that with the present exemplary embodiments, the container 101 could either transmit raw data (i.e., temperature or location data, or other types of data) to a server for data processing, or the container itself could process the data. For example, in one embodiment, the server 105 could process raw data so that the processing load on the container is reduced. On the other hand, the container could process the temperature and location data, or other types of data, and make determinations that are sent to the server 105 when it is preferable to implement local data processing. One example of this is that the container could determine whether the temperature exceeds a predetermined threshold, and transmit the result of the determination to the server. This process could of course be executed repeatedly.

FIGS. 6A and 6B will now be described. In FIG. 3A, the container 101 is slidingly attached to guide rails 601 and 602 disposed on vehicle 103. The protrusion 603 on the rear side of container 101 fits between the guide rails 601 and 602 to ensure a smooth fit. A user can slide the container downward through the guide rails to set the container 101 in place near the bottom of the guide rails. After the container 101 is set in place via the guide rails, the airflow connection 507 can connect to a corresponding airflow source (i.e., an external refrigeration unit as in FIG. 4B) so that the container 101 receives cooling air from an external source. As a result, the interior of the compartment can be maintained at a predetermined temperature. The guide rails 601 and 602 can be disposed at a place of business such as a warehouse, store, or a restaurant so that a restaurant operator can place food or other perishable items inside the container, and slide the container 101 into place as described above. Subsequently, the contents can be maintained at a predetermined temperature. Alternatively, the guide rails could be disposed at a user's home so that a user can receive a delivery of the container 101, and the container can connect to an airflow source so that the contents of the container are kept at a predetermined temperature.

In FIG. 6B, the vehicle 103 shown in FIG. 1 includes a mechanical connector 604 that connects to the container to secure the container in place in the trunk of the vehicle. Similar to the configuration shown in FIG. 6A, when the container 101 is secured in the vehicle, the airflow connection 507 can connect to a corresponding airflow source so that the container 101 receives cooling air from an external source, but it is not mandatory that the vehicle be equipped with a refrigeration unit. As a result, the interior of the compartment can be maintained at a predetermined temperature. If the vehicle does not include a refrigeration unit, the container can be passively cooled without receiving cooling air. Note that the mechanical connector 604 can be substantially similar to the guide rails 601 and 602 so that the container 101 can easily fit in both places (the restaurant/store/warehouse or the vehicle).

FIG. 7A will now be described. In FIG. 7A, an in-home cooling unit 701 is disposed inside a user's home, with a wall 702 between the container 101 and the cooling unit 701. The in-home cooling unit 701 includes a refrigeration module configured to generate and provide cooling or heating airflow to the container 101. The refrigeration module may include control electronics, an evaporator, a compressor, a condenser, an expansion valve, refrigerant fluid, a fan, and/or other components that may be used to generate cooling air. The in-home cooling unit 701 also includes a wireless communication unit configured to transmit data to a remote server or a user's smartphone, such as the temperature measurements from the container 101. When the container 101 is connected to the in-home cooling unit 701, the container 101 can maintain its interior at a predetermined temperature for an extended period of time because the cooling unit 701 receives power from a wall plug. Thus, when the container is connected to the in-home cooling unit 701, goods can be delivered to a user's home and kept cool (i.e., at a predetermined refrigeration or freezing temperature) up a time when the user approaches the container and opens it. This can permit the user to receive temperature-sensitive goods at his or her home without a risk of the goods being spoiled.

FIG. 7B will now be described. This configuration is similar to the configuration in FIG. 7A, except that the in-home cooling unit 701 includes a pipe 703 that connects to the container 101, and no wall is present between these two devices.

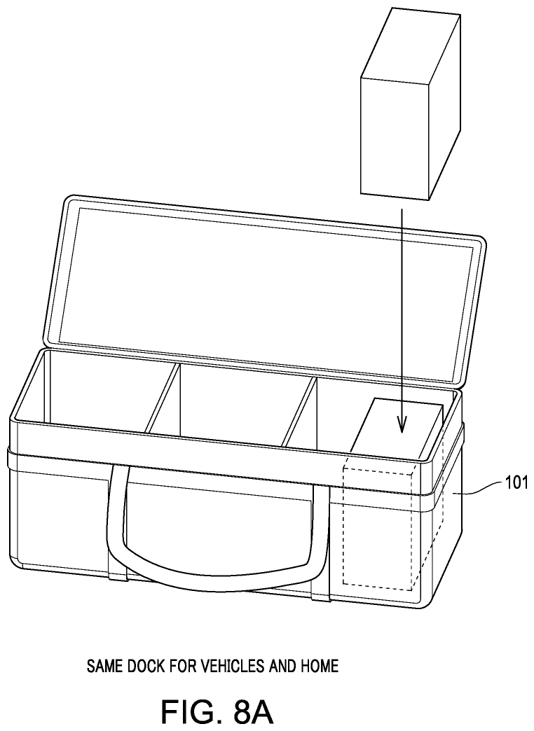

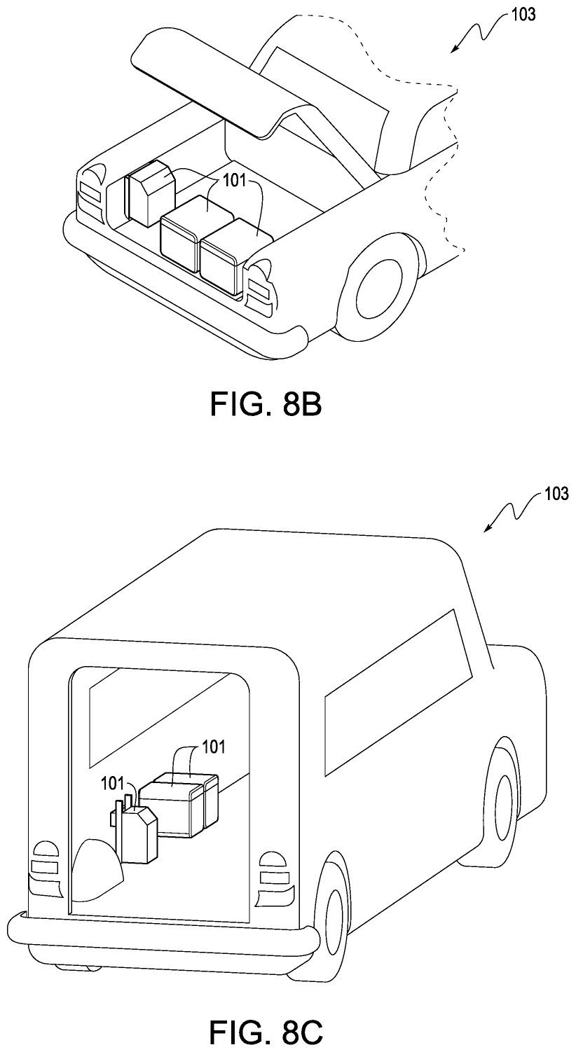

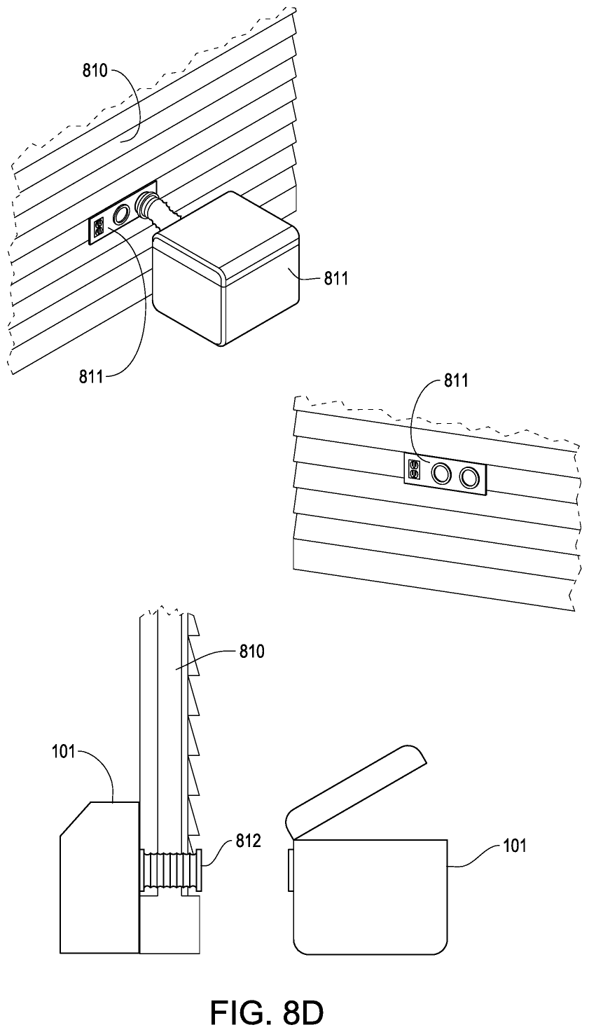

FIGS. 8A-8D will now be described. FIG. 8A illustrates how the container can fit inside a large box with an active cooling system: the large box can be installed at a user's home, so that the container 101 can be delivered and placed inside the large box. As an example of this large box, please see Applicant's other pending application U.S. application Ser. No. 17/214,236, published as US 2021/0304539, which is hereby incorporated by reference in its entirety.

In FIGS. 8B and 8C, the mechanical docking connector is configured so that the container 101 can fit into the vehicle 103. The same connector used at the delivery source (see FIG. 6A) may be used in the vehicle to provide a common connection system for the container at both the delivery source and the vehicle. The same connector could also be used at the user's home. Note that in FIGS. 8B and 8C the vehicle carries a plurality of containers. Accordingly, the container to be securely held in place at a delivery source, inside the vehicle, and at the user's home, with the same mechanical configuration.

FIG. 8D illustrates another embodiment of how the container can be located at a user's home or a delivery destination. That is, FIG. 8D illustrates a wall 810, the container 101, and an interface 811 that can supply cooling air to the container from a refrigeration source. Also illustrated is a pipe 812 that connects the container 101 and the refrigeration source. The refrigeration source is shown in FIG. 4B for example.

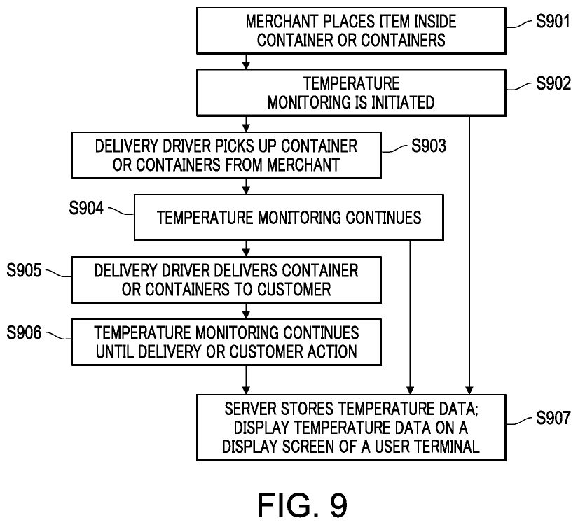

FIG. 9 illustrates a flowchart of an exemplary temperature monitoring process. This process could be implemented with a single container, or a plurality of containers that are loaded onto a vehicle for transport.

At step 901, a merchant such as a restaurant employee places an item inside the container 101. After the container is loaded with the item, at step 902, temperature monitoring is initiated while the container is held at the source location (i.e., a restaurant, a delivery hub, or a place where temperature sensitive goods are manufactured and/or packaged) awaiting pickup from a delivery agent. Specifically, the temperature sensor 501 periodically or continually monitors the interior of the container 101 and the processor 503 transmits the temperature sensor data, or temperature-related determinations, to a cloud server 105. In an alternative embodiment, the temperature monitoring could begin even before the item is placed inside the container to ensure that the item is initially placed in an environment with a suitable temperature.

At step 903 the delivery driver/agent subsequently picks up the container 101 from the source location. The delivery driver loads the container 101 into his or her car, and at step 904 the temperature monitoring performed by the container 101 continues while the driver is driving his vehicle and en route to a destination. Specifically, the temperature sensor 501 periodically or continually monitors the interior of the container 101 and the processor transmits the temperature sensor data or temperature-related determinations, to the cloud server 105. Optionally, location data from the container 101 can also be transmitted to the server during this step via the GPS receiver.

At step 905, the delivery driver delivers the container 101 to a customer, i.e., the final destination. At step 906, the temperature monitoring may end after delivery, but alternatively the temperature monitoring continues even after delivery. That is, while the container 101 is on the user's property and the user has not yet opened the container to remove the contents, the temperature monitoring performed by the temperature sensor 202 may continue. The temperature monitoring may end when the user opens the container to access the contents. Again, the container may send raw temperature data or temperature-related determinations, to the server at this stage.

Step 907 may occur concurrently with the temperature monitoring on the server side and/or on the terminal device 107. That is, the server 105 stores the temperature data or temperature-related determinations, that are transmitted from the container 101. The temperature data that is stored on the server 105 may be displayed on a display screen of the user terminal device 107 and viewed by a user.

By using this method, the temperature of the contents inside the container can be continually monitored from the store, through the delivery process, at the user's home, up until the user opens the container to access the contents. Thus, the temperature across the entire delivery chain can be recorded and monitored.

The temperature data can be sent to a driver (i.e., terminal device 102) or server 105. From the server 105, a retailer, a customer, or a delivery company may access the temperature data, and cause the data to be displayed on a display screen. Corporate entities that have access to this data can use the data to monitor driver performance and ensure that temperature sensitive goods are not spoiled during the delivery process.

Note that the periodic temperature monitoring may be performed at predetermined increments, for example, every 1 second, 2 seconds, 5, seconds, 10 seconds, every 30 seconds, every 60 seconds, every five minutes, et cetera. That is, the temperature monitoring does not necessarily have to be performed continuously. However if continuous measurement is desirable, the processor 204 could control the temperature sensor 202 to collect the data nearly continuously so that more frequent measurements can be acquired.

The measured temperatures can be used to monitor food chain temperature compliance. That is, suppose that a governmental entity requires that temperature sensitive food stay in a container below 40 degrees while being delivered to a destination. Note that the exact temperature is not critical and 40 degrees is just an example. The measured temperatures could be used to verify that the interior compartment of the container never went above 40 degrees. Alternatively, the governmental entity might require than the container storing the food not exceed 40 degrees for more than 5 minutes. Again, the measured temperatures could be used to verify that the interior compartment of the container went above 40 degrees for not more than 2-3 minutes, so compliance with the relevant regulation was achieved. Of course, the same advantage also applies to temperature-sensitive medicine such as insulin that cannot go above a certain temperature without risk of spoilage.

The measured temperatures can be used to evaluate delivery routes for temperature sensitive items such as food or medicine, but any type of perishable item could be used with the presently disclosed techniques. For example, suppose that insulin is delivered from location A, which is a warehouse storing the insulin, to location B, which is where a user of the insulin resides, with various waypoints/stopping points between locations A and B. If the temperature of the container exceeds a recommended temperature during the process of delivery, especially when the container lacks an active cooling system, it may be determined that the delivery route on which the insulin was sent is inefficient because the insulin went above a predetermined temperature and is subsequently spoiled. Consequently, a faster route from location A to location B can be judged to be necessary. This can improve the efficiency of delivery of temperature sensitive goods by reducing the risk of spoilage during transit.

The measured temperatures can be used to set target delivery times based on degradation predictions. For example, given the example above with regard to insulin being delivered from location A to location B, it may be determined that the risk of spoilage of the insulin is high if the delivery takes longer than 30 minutes. Therefore, 30 minutes could be set as a target delivery time based on past temperature measurements for a given route. This can improve the efficiency of delivery of temperature sensitive goods by reducing the risk of spoilage during transit.

The presently disclosed method can be used to improve delivery efficiency for cold chain delivery applications. That is, in a conventional scenario, cold chain goods are delivered directly from a source to a destination with a single stop, in less than a preset amount of time (e.g., 1 hour). This is because it is decided in advance that 1 hour is the maximum amount of time that the goods can be above a preset temperature, so a 1 hour delivery is guaranteed not to spoil the goods. However, if the temperature of the container housing the good is actively monitored over time (as described above in FIG. 9 for example), more packages can be delivered at multiple stops because the temperature can be measured and it can be verified that the temperature never exceeds a preset limit, so it is no longer necessary to impose a 1 hour delivery time limit. In other words, the delivery vehicle could take 2 hours to deliver multiple containers to multiple destinations, and the temperature data confirms that the goods will remain unspoiled during this 2 hour delivery time period.

In an additional step, a driver of the vehicle that transports the container can be alerted if a scheduled delivery time has expired, or may expire within a predetermined amount of time. For example, suppose that a target delivery time is 30 minutes as described above. The server 105 could store the measured temperatures, and the target delivery time, and transmit a notification to the driver's smartphone, or transmit a notification directly to the vehicle, indicating the driver has 5 minutes to deliver the container before spoilage. Alternatively, the server could and transmit a notification to the driver's smartphone, or transmit a notification directly to the vehicle, indicating the item is already spoiled and that it must be discarded. This can improve the efficiency of delivery of temperature sensitive goods by reducing the risk of spoilage during transit and/or prevent spoiled goods from being handed over to a purchaser.

In addition to the location and temperature data, other data points can be collected and stored by the server 105. For example, the type of items packed in the container can be stored. The specific time at which the goods are packed can be stored, as well as the pickup time, travel time, and time at which the container is opened while present at the destination. Predetermined temperature thresholds can also be stored. Temperature readings that violate/exceed the predetermined temperature thresholds, along with the time of the violation, the length of the violation, and location of the violation can be stored. By storing and analyzing this data, cold chain compliance can be monitored and improved. Any or all of these data points can be displayed on a user terminal device to monitor the cold chain compliance.

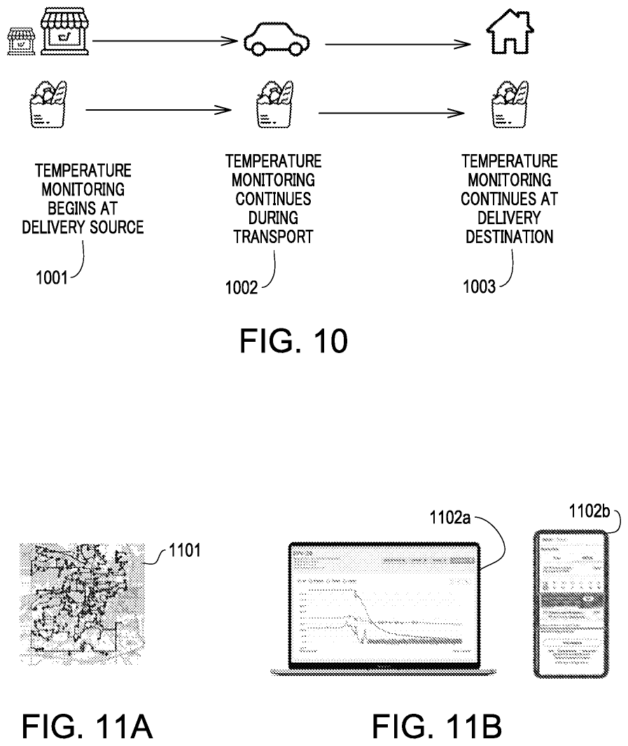

FIG. 10 illustrates the method of FIG. 9 in an alternative manner. In general, at 1001 the temperature of the container is continually or periodically monitored from a delivery source such as a store, throughout transport of the container (at 1002), and after delivery at the destination (i.e., the user's door) at 1003. Thus, the temperature of the container can be tracked over a plurality of locations and over a time period from the store to the door.

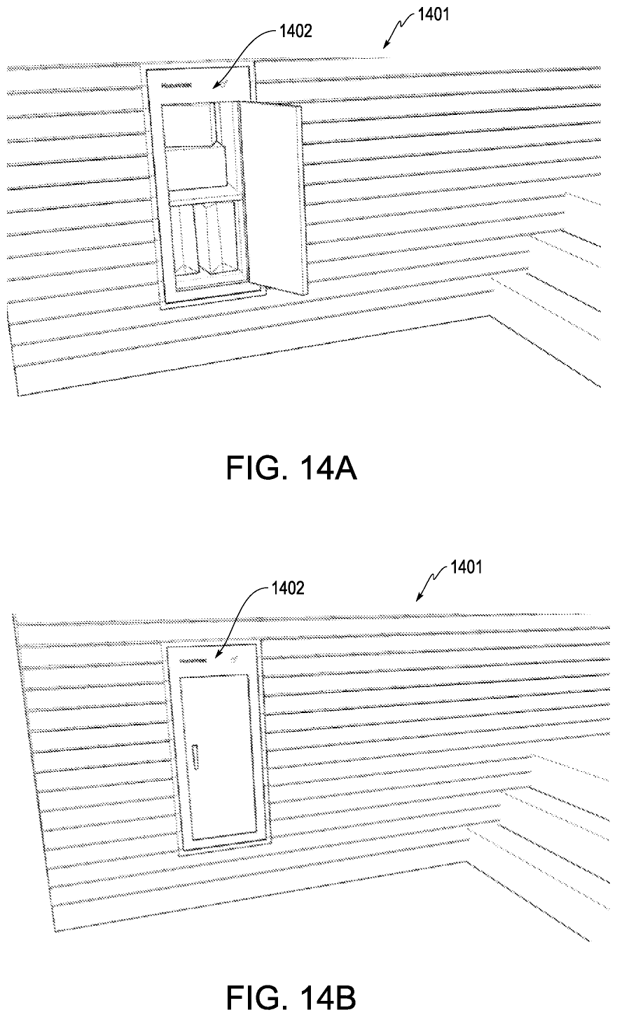

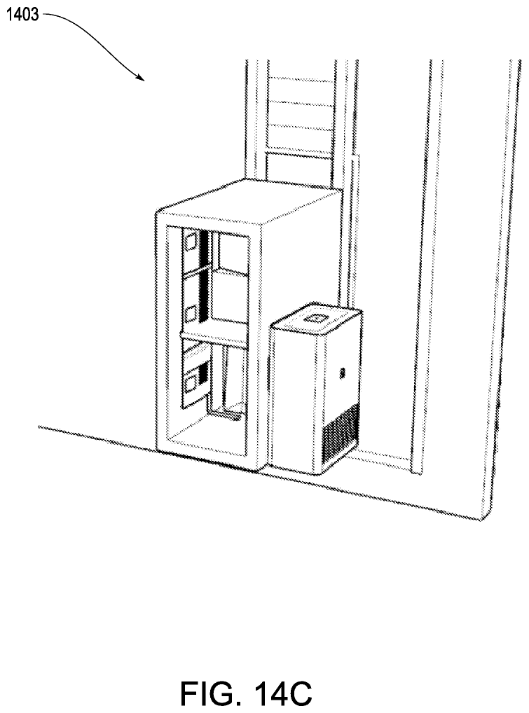

It should be noted that in the process flow of FIG. 10, data can be collected from three different containers at steps 1001, 1002, and 1003 respectively. For example, at the delivery source, the item can be placed inside a first container, i.e. a standard refrigerator or a warehouse section, and a first temperature sensor can monitor the temperature around the item at step 1001. At step 1002, the item is loaded into a delivery vehicle and into a second container that includes a second temperature sensor (see FIG. 8C for example). At step 1003, the item is loaded into the cubby shown in FIG. 14A or a freestanding “smart” container (either of these could be the third container), and the third container also includes a third temperature sensor. At each step, the temperature is monitored, and each container includes wireless communication circuitry that can transmit data, either raw temperature data or temperature-related determinations (e.g. preset temp exceeded?) to a server. The complete temperature history of the item while present at the delivery source, during transport, and up to and including while present at the delivery destination can thus be gathered and stored on the server (i.e., a gapless history) to monitor cold chain compliance of the item from store to door. For example, temperature readings every 1 minute, 2 minutes, 5 minutes, et cetera can be gathered through steps 1001-1003. The temperature readings may end when the user opens the third container to access the temperature sensitive item. Consequently, assurance can be provided that the temperature sensitive item was never exposed to spoilage conditions at any point from store to door, due to the complete history obtained from successive containers that store the item in sequence and that each transmit information to the server.

An exemplary table with time, temperature, and location data that is collected with the above-described techniques is shown below in Table 1. This data may be generated from the temperature sensor and GPS microchip described above, and transmitted to and stored in the server. Alternatively, the container may store and process the timing, temperature and location data, and transmit messages such as the “Item Safe?” determination shown in Table 1 rather than raw temperature data. For example, the container could repeatedly determine whether or not a predetermined temperature has been exceeded for, e.g., 5 minutes or longer. If this condition occurs, it may be determined that the food or the other type of temperature sensitive item in the container is no longer safe for use. In table 1 the item/food is determined to be unsafe when the temperature exceeds 32.0 degrees for a given length of time (1 minute, 2 minutes, 5 minutes, 10 minutes, et cetera).

The time, temperature, and position data in Table 1 can be displayed on a display in various ways. A chart with historical temperature data could be displayed, or a screen with live temperature readings could be displayed, or a combination of these two features could be displayed. Alternatively, a table similar to Table 1 could be displayed. The location history could be displayed in the form of a path superimposed over a map, or as an icon indicating a real-time location of the container. Note that the particular numbers below are merely exemplary and are not intended to be an exact representation of real-world conditions. For example, the temperature data could be collected at various intervals, and the timing is not limited to 1 minute intervals.

TABLE 1

| Time | Temperature | Location | Item Safe? |
|---|---|---|---|
| 2:30 PM | 31.0 degrees | 40.741895, | Yes |
| | | −73.989308 | |
| 2:31 PM | 31.1 degrees | 40.741894, | Yes |
| | | −73.989309 | |
| 2:32 PM | 31.2 degrees | 40.741893, | Yes |
| | | −73.989310 | |
| . . . | . . . | . . . | |
| 3:00 PM | 32.5 degrees | 40.7433066, | No |
| | | −74.0323752 | |

Note that a wide variety of other data points can be associated with the temperature and location data in practice, in order to link this data to specific customer orders. For example, the temperature and location can be associated with a customer ID, an order ID, a time the order was placed, a number of items in the order, time length to pick and pack the order, a live timer of delivery time, categorization of items (dry, cold, liquid, solid), time stored in a back room, time at which the item is transferred to a vehicle, time at which the item is delivered, driver ID, delivery address, ETA, a local outside temperature (e.g. zip code temperature), et cetera. By collecting these data points and associating them with the temperature and location data, insight into how specific customer orders satisfy or fail to satisfy cold chain compliance can be achieved. These additional data points can be stored in the server, and newly received temperature data can be added and associated with e.g., customer ID and the other data points. With this configuration, a user can also track the progress of the item being delivered, in terms of its temperature, as the item undergoes the delivery process.

FIGS. 11A and 11B illustrate various display screens that can be displayed on a terminal device such as terminal device 102 or terminal device 107. In FIG. 11A, the location of the container is tracked over time, so that its path from a delivery source, its journey in a vehicle, and its destination location are recorded (via GPS), stored in cloud server 105, and finally displayed for a user on the terminal device via display screen 1101. This permits the retailer or customers to track the location of the temperature-sensitive goods over time. In FIG. 11B, the temperature data is recorded, stored in server 105, and displayed on a terminal device such as terminal device 102 or terminal device 107 via display screen 1102A or 1102B. This permits the retailer or customers to track the ambient temperature around the temperature-sensitive goods (inside the container) over time. Of course, the location history/path and temperature data could be displayed on a single screen if necessary.

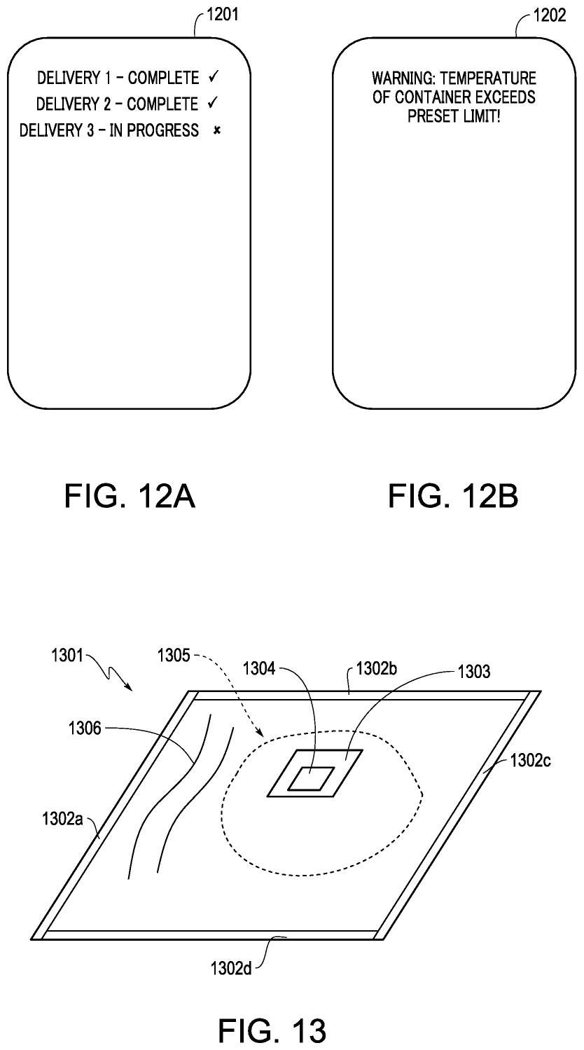

FIGS. 12A and 12B illustrate additional display screens that may be displayed on a terminal device such as terminal device 102 or terminal device 107. In FIG. 11A, a driver who carries terminal device 102 can mark off which deliveries of multiple containers have been completed on display screen 1201. This information can be sent to, and stored in, server 105. In FIG. 11B, terminal device 102 or terminal device 107 (devices of the driver, customer, or retailer) could display a warning indicating that the temperature of the container exceeds a preset limit, exceeds a preset limit for a predetermined amount of time, or will soon exceed a preset limit for a predetermined amount of time on display screen 1202. Optionally, the current temperature or a predicted temperature could be displayed, as well as the preset temperature limit.

FIG. 13 illustrates an additional embodiment that is an alternative physical configuration that be used instead of the container 101, but would perform similar functions as described above for the container 101. In this additional embodiment, instead of a container, an insulated sheet 1301 with weighted edges 1302a-1302d could be provided that is placed over the item to be delivered 1305. Optionally, the insulated sheet could include airways 1306 to distribute cooling air. The sheet would include a small chip 1303 with a temperature sensor 1304 that measures temperature data and transmits the data to another device, such as a user terminal, a cell tower, or an in-vehicle electronic device via a wireless communication protocol. A battery may be included. The sheet could optionally include a processor and memory installed in the chip so that the temperature data can be stored and/or processed. A GPS microchip could also be included in the chip 1303. Overall, the sheet 1301 would repeatedly measure temperature data over time so that cold chain compliance could be monitored continuously from a point of origin, during travel of an item to be delivered, and after delivery at the destination. The sheet, or a server that receives data therefrom, could then determine whether the item that is delivered achieved cold chain compliance (i.e., not above 32 degrees for more than 5 minutes, though these numbers are arbitrary and only a simple example). The insulated sheet could be made from a material that slows down heat transfer, such as a flexible plastic.

FIGS. 14A-14C illustrate another aspect of the store-to-door system. In this embodiment, a small or medium sized cubby 1402 is permanently installed at a user's home and is integrated with wall 1401. The cubby includes a door member. The cubby is on the outside of the user's home so that a delivery agent can open the door and deliver goods to the interior of the cubby. On the back side of the wall 1401, there is a cooling unit 1403 that can generate and deliver cool air to the cubby. The cooling unit 1403 may have the same configuration as the in-home cooling unit 701 described above. With this configuration, cold chain compliance monitoring can continue to be performed even after a temperature sensitive good is delivered to the user's home and stored in the cubby. That is, the cubby may include a temperature sensor at any portion on the interior, and the temperature sensor can repeatedly measure the temperature over time (e.g., every 30 seconds, 1 minute, 2 minutes, or 5 minutes, et cetera), and transmit the temperature data along with timestamps to a server. Thus, if the temperature inside the cubby goes higher than a preset temperature limit (i.e. 32 degrees) for more than a predetermined amount of time (i.e., 5 minutes), a user can be alerted that the temperature sensitive item inside the cubby has been spoiled. In addition, a company that either produced the item, or a company that delivered the item, can have access to a complete picture of the temperature history of the item from the moment the item leaves the store, during transport of the item, and including the time period during which the item is delivered and stored in the cubby. The complete temperature history from store to door enhances cold chain compliance.

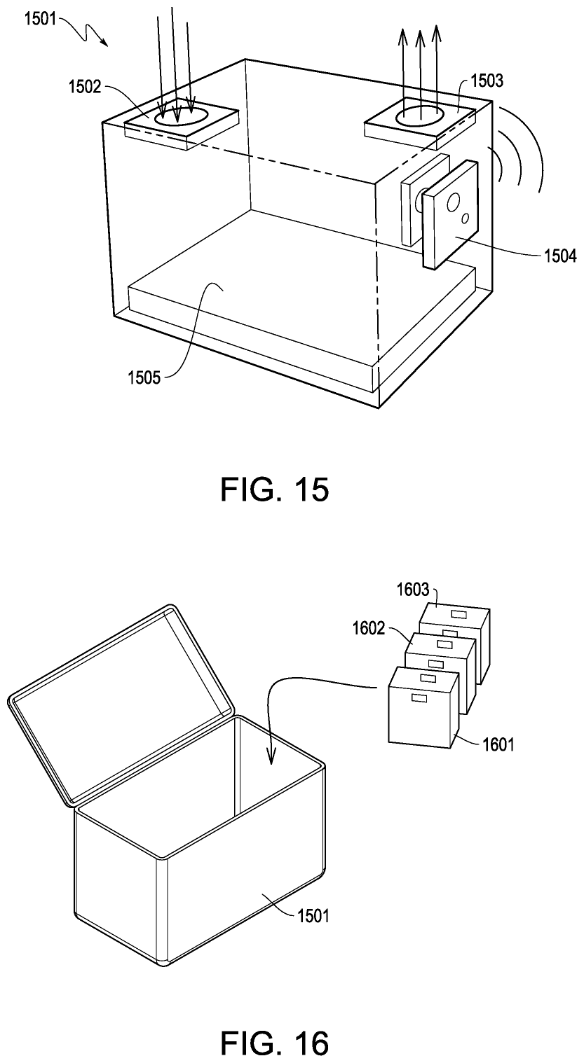

FIG. 15 illustrates another embodiment of the “smart” version of the container. In this embodiment, the container 1501 is a self-regulating container that can monitor and regulate its internal temperature. The container includes at least one intake fan 1502, and multiple fans of this type could be used. The container also includes an exhaust fan 1503, and multiple fans of this type could be used. Also included is a sensing and communication puck 1504 that includes at least two temperature sensors. A first temperature sensor on the exterior side of the container measures ambient air temperature, and a second temperature sensor on the interior side of the container measures an interior temperature of the container. A difference between ambient and interior temperatures can be measured. A controller or processor may be provided to control operations of the fans and the puck 1504. For example, the fans can be activated based on the temperature differential between inside and outside. A phase change material 1505 may also be included. A phase change material is a substance which releases or absorbs energy at phase transition to provide useful heat or cooling.

By measuring outside ambient air temperature and the interior temperature, the fans turn on and either inhale cold air to cool and/or exhale warm air to regulate the interior temperature of the container. In addition, the phase change material can be activated to absorb heat and cool the interior.

The sensing and communication puck 1504 can include wireless communication circuitry that is configured to transmit data, such as the measured temperature data or temperature-related determinations (i.e., that the measured temperature is above a predetermined threshold for a given time or longer). The wireless communication circuitry can be configured to communicate via Wi-Fi, 4G, 5G, Bluetooth, or other communication modes. The data can be sent to a server and stored on the server so that a history of the temperature over time is stored. The transmitted data can be used to monitor safety of goods inside the container. In addition, the container 1501 in FIG. 15 may include any of the components shown in FIG. 5.

FIG. 16 shows small caddies 1601-1603 that can be placed in the container. The container 1501 may include three interior compartments, and each compartment can be fitted with a small caddy. The caddies can be made of plastic or fabric. The caddies may have a geometry that permits airflow within the container such as a vent hole or a plurality of vent holes on the sides. The caddies may be insulated or have phase change material embedded therein. This system makes it easier to transfer items to and from the container.

It is to be understood that while the invention is disclosed in certain forms and embodiments, it is not to be limited to the specific forms or embodiments or parts or methods described and shown herein. It will be apparent to those skilled in the art that various changes may be made without departing from the scope of the invention and the invention is not to be considered limited to what is shown in the drawings and described in the specification. Different embodiments disclosed herein can be combined in various ways because the embodiments generally relate to measuring temperature from store to door.

What is claimed is:

1. A method of monitoring, with a temperature sensor, a temperature of an interior compartment of a container that stores an item, the method comprising:
a first step of measuring a first temperature of the interior compartment of the container, the first step occurring while the container is stationary and present at a delivery source;
a second step of measuring a second temperature of the interior compartment of a container, the second step occurring while the container is being transported by a vehicle to a destination and after the first step;
a third step of measuring a third temperature of the interior compartment, the third step occurring after the container has been delivered to the destination, while the container is stationary, and after the second step; and
transmitting either (i) information comprising the first, second, and third temperatures to a server or (ii) information related to the first, second, and third temperatures to the server, and controlling the server to store the first, second, and third temperatures or the information related to the first, second, and third temperatures.

2. The method according to claim 1, further comprising controlling a user terminal device to display at least one from among the first, second, and third temperatures or information related to the first, second, and third temperatures on a display screen of the user terminal device.

3. The method according to claim 1, further comprising determining, based on either (i) the information comprising the first, second, and third temperatures or (ii) the information related to the first, second, and third temperatures, whether or not the item has been exposed to an ambient temperature that is above a predetermined threshold.

4. The method according to claim 1, wherein the temperature sensor is a portable and battery-powered temperature sensor that is disposed within the interior compartment.

5. The method according to claim 1, wherein the temperature sensor is mechanically integrated with the container.

6. The method according to claim 1, wherein the container includes a mechanical docking connector that is configured to mate with a complementary docking station disposed on the vehicle so as to lock the container in place during transport.

7. The method according to claim 1, wherein while the container is being transported by the vehicle, the second step includes transmitting a notification to a user terminal device associated with a driver of the vehicle when a preset scheduled delivery time for the container is due to expire within a predetermined time.

8. The method according to claim 1, wherein while the container is being transported by the vehicle, the second step includes transmitting a notification to a user terminal device associated with a driver of the vehicle when a preset scheduled delivery time for the container expires.

9. The method according to claim 1, wherein the information related to the first, second, and third temperatures is a message indicating that a predetermined temperature has been exceeded at a specific time, or a message indicating the predetermined temperature has not been exceeded at a specific time.

10. A method of monitoring, with a temperature sensor, a temperature of an interior compartment of a container that stores an item, the method comprising:
a first step of periodically measuring the temperature of the interior compartment of the container, the first step occurring while the container is stationary and present at a delivery source;
a second step of periodically measuring the temperature of the interior compartment of a container, the second step occurring while the container is being transported by a vehicle to a destination and after the first step;
a third step of periodically measuring the temperature of the interior compartment, the third step occurring after the container has been delivered to the destination, while the container is stationary, and after the second step; and
periodically transmitting either (i) information comprising the measured temperatures from the first, second, and third steps to a server or (ii) information related to the measured temperatures to the server, and controlling the server to store the measured temperatures or the information related to the measured temperatures.

11. The method according to claim 10, further comprising controlling a user terminal device to display at least one from among the first, second, and third temperatures or information related to the first, second, and third temperatures on a display screen of the user terminal device.

12. The method according to claim 10, further comprising determining, based on either (i) the information comprising the first, second, and third temperatures or (ii) the information related to the first, second, and third temperatures, whether or not the item has been exposed to an ambient temperature that is above a predetermined threshold.

13. The method according to claim 10, wherein the third step is terminated when the item is removed from the container and the container is located at the destination.

14. The method according to claim 10, wherein the temperature sensor is a portable and battery-powered temperature sensor that is disposed within the interior compartment.

15. The method according to claim 10, wherein the temperature sensor is mechanically integrated with the container.

16. The method according to claim 10, wherein during the first step, the second step, and the third step, location data indicating the location of the container is periodically determined and transmitted to the server.

17. A method of monitoring a temperature of an interior compartment of each of a first container, a second container, and a third container that successively store an item during a delivery process, the method comprising:
a first step of periodically measuring the temperature of the interior compartment of the first container with a first temperature sensor, the first step occurring while the first container is stationary and stored at a delivery source;
a second step of periodically measuring the temperature of the interior compartment of the second container with a second temperature sensor, the second step occurring while the second container is being transported by a vehicle to a destination and after the first step; and
a third step of periodically measuring the temperature of the interior compartment of the third container with a third temperature sensor, the third step occurring while the third container is stationary, present at a delivery destination, and after the second step.

18. The method according to claim 17, further comprising periodically transmitting either (i) information comprising the measured temperatures from the first, second, and third steps to a server or (ii) information related to the measured temperatures to the server, and controlling the server to store the measured temperatures or the information related to the measured temperatures.

19. The method according to claim 18, wherein the information related to the first, second, and third temperatures is a message indicating that a predetermined temperature has been exceed at a specific time, or a message indicating the predetermined temperature has not been exceeded at a specific time.

20. The method according to claim 18, further comprising determining, based on either (i) the information comprising the first, second, and third temperatures or (ii) the information related to the first, second, and third temperatures, whether or not the item has been exposed to an ambient temperature that is above a predetermined threshold.
